(19) United States
(12) Patent Application Publication
(10) Pub. No.: US 2007/0203911 A1
(43) Pub. Date: Aug. 30, 2007

(54) Video weblog

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,857

(22) Filed: Feb. 28, 2006

(51) Int. Cl. G06F 17/30

(52) U.S. Cl. 707/10

(57) ABSTRACT

A web-based video log that allows users to present video segments on-line in a chronological format is disclosed. A user friendly interface and system is provided for allowing users to place video or other multimedia on a personal website space. Users can record video directly to a central server without having to record the video locally on their computer and then upload the file via file transfer protocol. Alternatively, users can upload video files in any format and codecs located on the server automatically convert the original format into a common format so that all users will be able to view the video. Video effects can be automatically added to the video. The amount of effect and various parameters for the effect can also be selected. Meta-tags are added so videos can be searched for and located. Users can personalize their VLOG but customizing the background.

### BACKGROUND OF THE INVENTION

1. Field of the Invention

The present invention relates to web-based journal. More specifically, the present invention discloses web log that uses video segments for journal entries and allows users to create online presences or introductions video multimedia.

2. Description of the Prior Art

Traditionally, individuals can create websites to introduce themselves or present products or services that are offered. These types of websites tend to be static and rely extensively on text or pictures. However, this type of website lacks personalization and therefore, users tend to become quickly bored, browse away from the website, and seldom return again.

A particular type of website for introducing oneself is a web log or BLOG. This type of site is based on a conventional diary or journal where entries are chronological. Users upload text to the entries regarding their accomplishments or other activities they have recently participated in. However, BLOGs really mainly on the user's writing ability rather than on their personality. As a result, users have a difficult time expressing themselves accurately.

Therefore there is need for a web-based journal system that provides means for accurately showing one's personality by using video segments or multimedia as entries.

### SUMMARY OF THE INVENTION

To achieve these and other advantages and in order to overcome the disadvantages of the conventional method in accordance with the purpose of the invention as embodied and broadly described herein, the present invention provides a web-based video BLOG (VLOG) system that allows users to easily present video segments on-line in a chronological format.

An object of the present invention is to provide a user friendly interface and system for allowing users to easily and conveniently place video or other multimedia on a personal website space.

The present invention allows users to record video directly to a central server or servers without having to record the video locally on their computer and then upload the file via file transfer protocol (FTP) or other system. As a result, users do not have to have means for capturing video. Users simply press record and video images captured by their web camera are sent directly to a server.

Alternatively, if the user prefers, they can upload video files in any format such as .avi, .mpg, .mpeg, .rm, .wmv, .mov, etc. Codecs located on the server can then automatically convert the original format into a common format so that all users will be able to view the video.

When using the on-line video record option, the present invention allows the users to use various filters to automatically add video effects to their video. In addition, the amount of effect and various parameters for the effect can also be changed by the user.

The present invention also allows users to supply various tags or meta-tags, so that videos can be searched for and located by name, topic, subject, author, date, user data, etc.

Additionally, users can conveniently personalize their VLOG but customizing such things as, for example, background image, color, font, layout, etc. without any programming required. Users simply select pre-arranged options and the site is reconfigured.

One aspect of the present invention allows users to construct their own virtually television station and provide personally selected or recorded video segments to other users. Continuous video can be displayed in an order according to a video playback playlist.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a drawing illustrating an example VLOG according to an embodiment of the present invention;

FIG. 2 is a drawing illustrating file maintenance for other user supplied videos for the VLOG according to an embodiment of the present invention;

FIG. 3 is a drawing illustrating basic setup for the VLOG according to an embodiment of the present invention;

FIG. 4 is a drawing illustrating background theme setup according to an embodiment of the present invention;

FIG. 5 is a drawing illustrating account information according to an embodiment of the present invention;

FIG. 6 is a drawing illustrating comments maintenance according to an embodiment of the present invention;

FIG. 7 is a drawing illustrating video file maintenance according to an embodiment of the present invention;

FIG. 8 is a drawing illustrating on-line recording options according to an embodiment of the present invention;

FIG. 9 is a drawing illustrating file upload status according to an embodiment of the present invention; and

FIG. 10 is a drawing illustrating video comments page according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

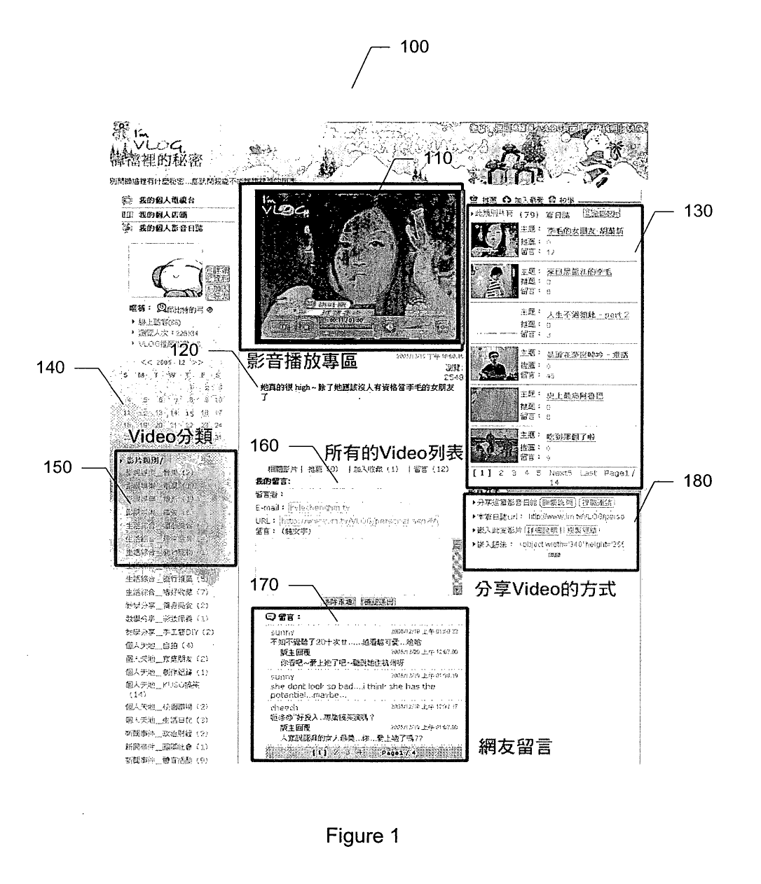

Refer to FIG. 1, which is a drawing illustrating an example VLOG according to an embodiment of the present invention.

As shown if FIG. 1, the VLOG website 100 comprises a video display area 110, a text description area 120, a video archive preview area 130, an entry calendar 140, a video category area 150, a user comment area 160, a comment list area 170, and a video share area 180.

In the video display area 110, the video of the day is displayed. Playback is typically set to automatic so that when a user visits the page, the video automatically begins playing. In other embodiments, the playback is started by pressing play. The display interface further provides transport controls over playing of the video. The controls are, for example, repeat, mute, pause, stop, volume, large screen select, etc. Additionally, the progress of the video playback is displayed in a progress bar. By clicking on the large screen button, the video is displayed in a pop-up display area at, for example, ½ screen, ¾ screen, or full screen size.

Below the video display area 110 is a text description area 120. The text description area 120 contains user provided text to describe the video or to convey other text information. For example, the text could be a description of the contents, feelings or opinions about the video or subject, etc.

Underneath the text description area 120 is a user comment area 160. This allows viewers to provide feedback regarding the video. The interface for the user comment area 160 is arranged to be similar to an email client. As a result, users simply need to type in their comments and press send. The comments are automatically added to the VLOG in the comment list area 170 which is a list of comments made by users who watched the video and provided comments. Users can jump between pages of comments by clicking on a page number.

In an embodiment of the present invention, users can provide feedback or comments via a video. For example, if user A provides a video self-introduction on their VLOG, user B can record a video that contains an introduction to user B and any comments user B has about user A or user A's video. This embodiment is optimal for dating or job interview type VLOGs. Utilizing the video feedback of the present invention allows users to add personality to their comments where text only would not suffice.

To the right of the video display area 110 is a video archive area 130 which provides screenshots or still frames of previous videos. Users can easily jump to the VLOG page for a particular video by clicking on the screenshot and the appropriate page will show up and the new video will begin playback.

An entry calendar 140 displays in highlight which days videos were added. Users can skip to the desired day by clicking on the date. Additionally, the calendar 140 can be scrolled forward or backward in month intervals.

Below the calendar 140 is a video category area 150 in which all the videos are sorted into categories for easy access. A user can select which category they are interested in and a new page will show up with screenshots of all the videos in that category displayed in the video archive area. The number of videos in a particular category is displayed after the category title.

In the video share area 180, the url of the video is displayed. This url can be copied into the .html file for another web page and the video will automatically be displayed in the new page. This allows users to conveniently share videos with other users and other websites.

It should be noted that the layout of the various windows or panes can be arranged to meet requirements. Additionally, some areas or panes may be omitted if desired.

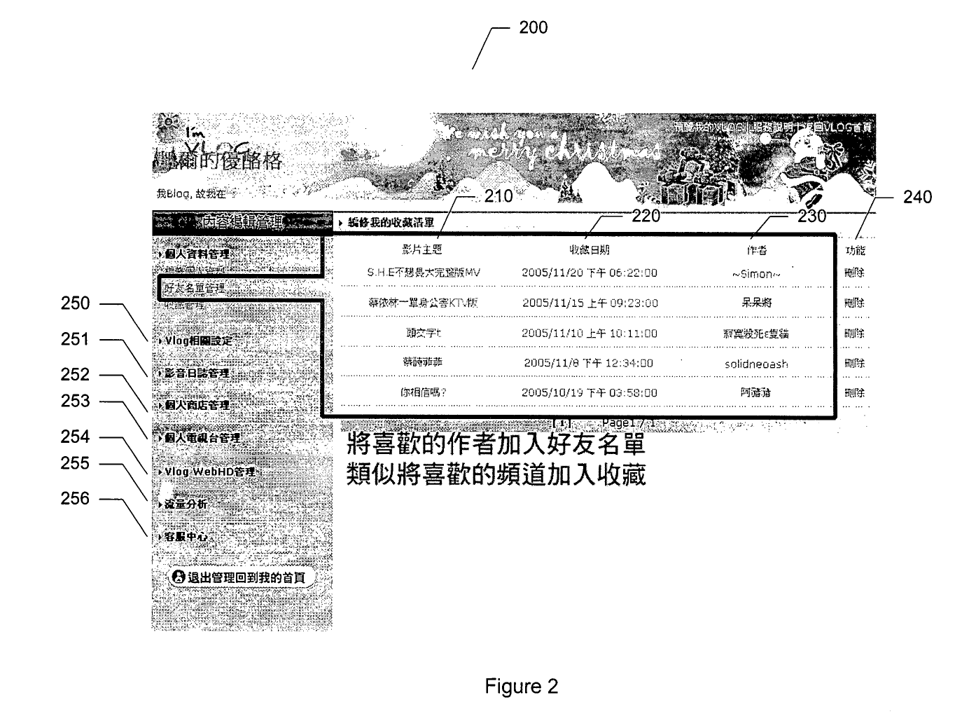

Following is a more detailed description of the setup and maintenance of the VLOG. Refer to FIG. 2, which is a drawing illustrating file maintenance for other user supplied videos for the VLOG according to an embodiment of the present invention. As shown in FIG. 2, the file information maintenance section 200 provides information regarding friend information. Not only can an individual provide videos for display on their personal VLOG site, but friends or other users can supply videos as well. The friends file information maintenance section 200 lists information in a video name column 210, date the video was uploaded or shared column 220, and the creator or author of the media column 230. This allows a user to easily manage the various videos others have provided. There is also an option to delete the file in the delete column 240.

Other sections that are available are displayed in a menu on the left side of the page. Various sections are VLOG setup 250, Video Diary maintenance 251, personal store maintenance 252, personal TV station maintenance 253, Web HD maintenance 254, views/reports 255, and customer service 256. Users can switch between the sections by clicking on the desired menu option.

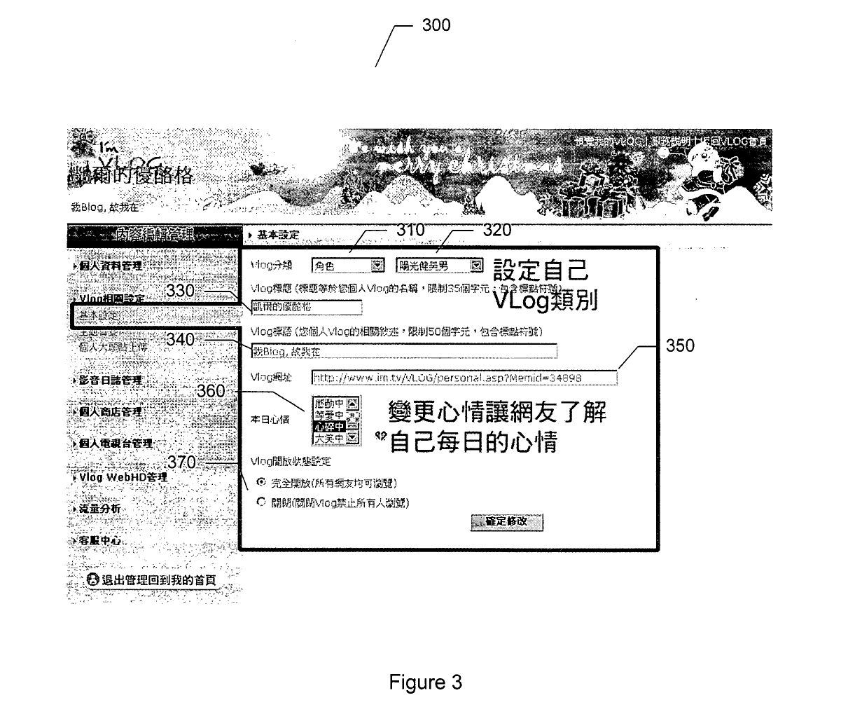

Refer to FIG. 3, which is a drawing illustrating basic setup for the VLOG according to an embodiment of the present invention. The basic setup page 300 provides options for personalizing the VLOG. The VLOG type 310 identifies the target type of the VLOG site. The VLOG type 310 can be selected from a menu including such occupations, hobbies, or interests that the VLOG creator has. For example, the type could be designer, writer, musician, music, art, movies, etc. This allows others who are interested in a certain area, to easily locate other VLOGs of similar interest.

Another option to identify the VLOG is a personality select option 320. Users can select what type of personality they are or what attributes they have. For example, handsome young man, romantic lady, sporty, intelligent, creative, etc. Users can locate compatible VLOG creators by searching for the desired personality.

An introduction name section 330 contains text introducing or describing the VLOG. An about section 340 allows users to provide further information about the VLOG. This text is displayed in the banner section of the page.

The VLOG uniform resource locator (URL) section 350 contains the URL of the VLOG's main page.

An emotion option 360 allows users to select an emotion descriptor that illustrates how they are feeling today. For example, happy, broken hearted, laughing, etc. This allows users to change their VLOG emotion in order to let others know how they are feeling today. The emotion option 360 adds feeling to the VLOG experience and creates a more organic feeling or community atmosphere ensuring users will interact personally rather than isolated by technology.

The VLOG can be set to be open to all users or can be a closed VLOG or open to selected users. This is set by the public/private select option 370. This allows the VLOG to be set up to be a member or friend only VLOG.

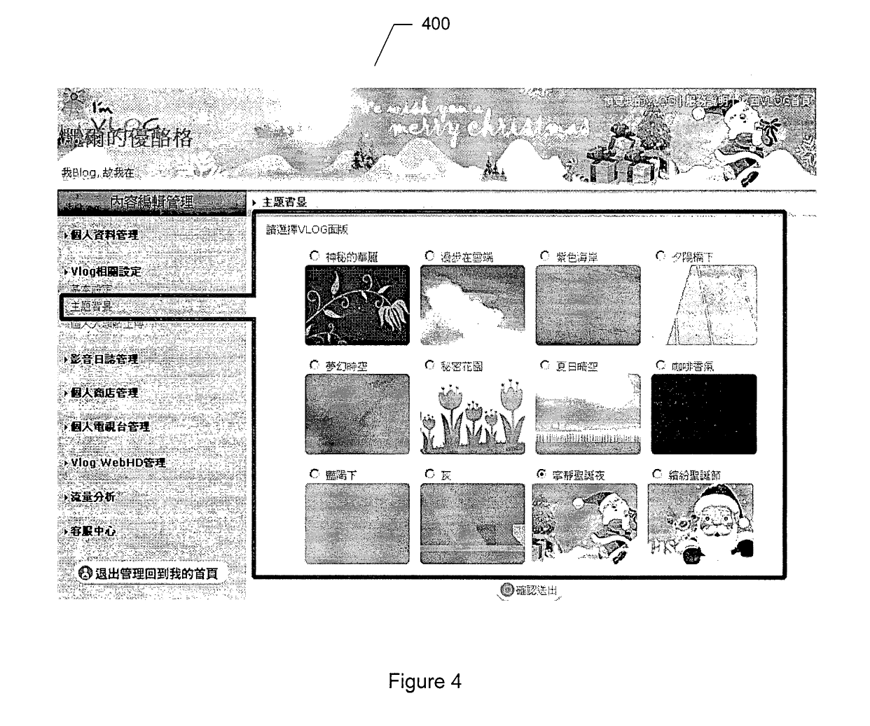

Refer to FIG. 4, which is a drawing illustrating background theme setup page 400 according to an embodiment of the present invention. Users can select what type of background or theme they would like for their VLOG. Typically, these are preset themes with defined background and color templates. This allows users to easily personalize their VLOG with now programming experience. However, in other embodiments of the present invention, users are allowed to upload their own backgrounds or themes. The available background themes are displayed in a background select area 400. Users simply need to select which one they prefer and the VLOG is reconfigured with the selected background.

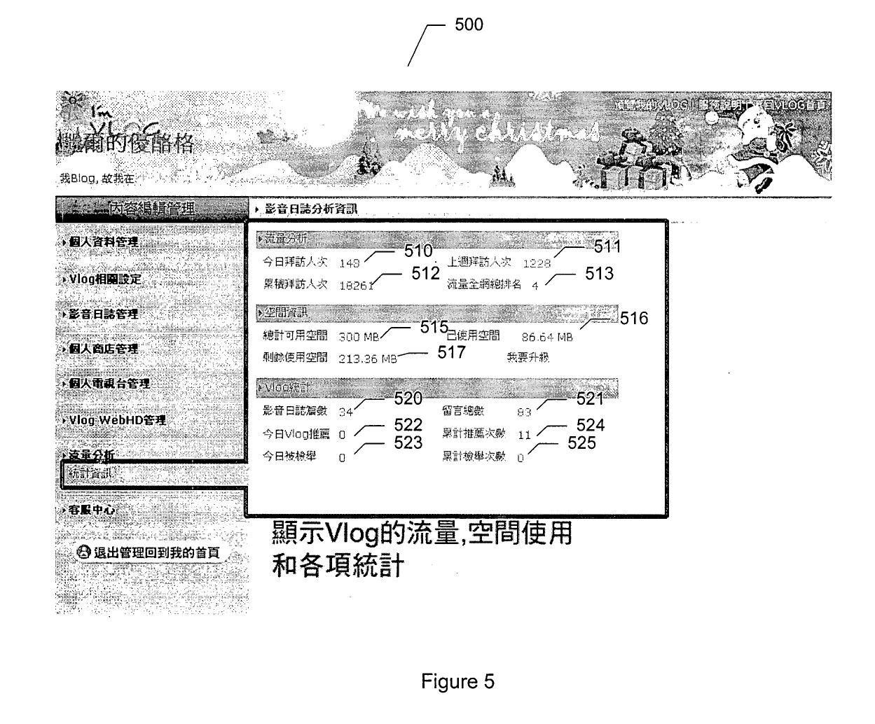

Refer to FIG. 5, which is a drawing illustrating account information 500 according to an embodiment of the present invention. Users can quickly see what the level of activity that their VLOG is generating. Information includes the number of today's views 510, the number of last week's views 511, the number of lifetime total views 512, and the ranking of their VLOG 513. The ranking can be given, for example, by category, total users, location, or other user information or VLOG descriptor.

In order to let the user know size information about their account, the amount of available space 515, the amount of used space 516, and the amount of free space left is displayed 517. Users can conveniently monitor and manage their account space and delete old or unused files when free space runs low.

Other information on this page is the total number of videos 520 in the VLOG and total number of comments 521. Users are allowed to vote or rank individual videos. The number of today's positive votes 522, total positive votes 524, today's negative votes 523, and total negative votes 525 are displayed in order to give users a sense of the level of user appreciation for their VLOG.

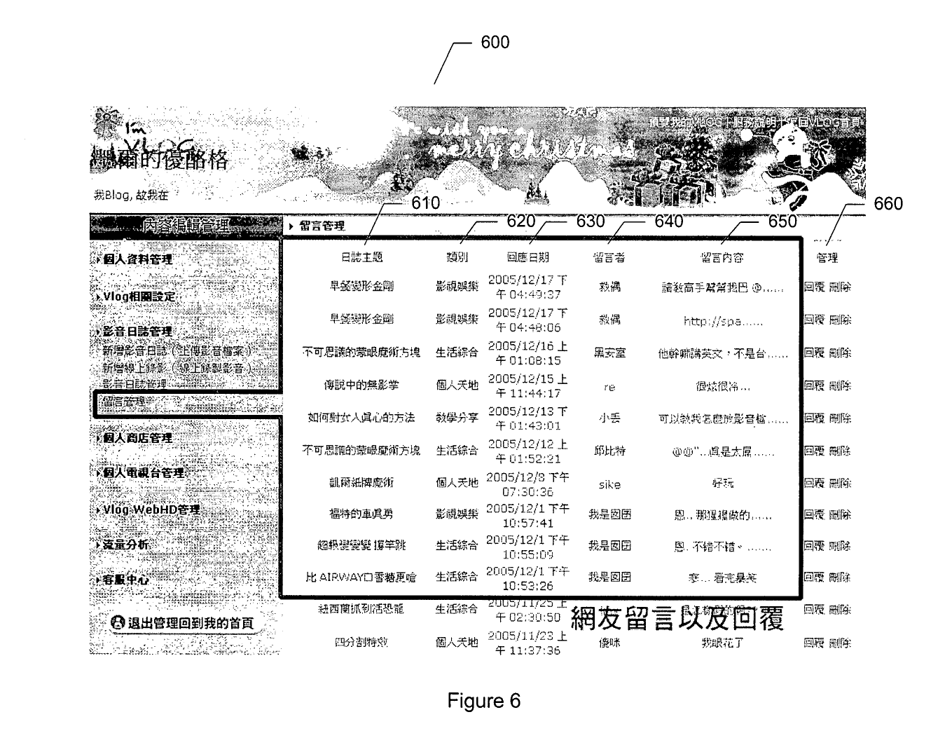

Refer to FIG. 6, which is a drawing illustrating comments maintenance section 600 according to an embodiment of the present invention.

A user can maintain the comments or feedback provided by other users. This page lists the video name the comment is in regard to 610, the type or category of the video 620, the comment date 630, the commenter 640, and the comments 650. The user can choose to delete the comment, leave the comment, or answer the comment in the action column 660. In this way, undesirable or inappropriate comments can be easily removed from the VLOG.

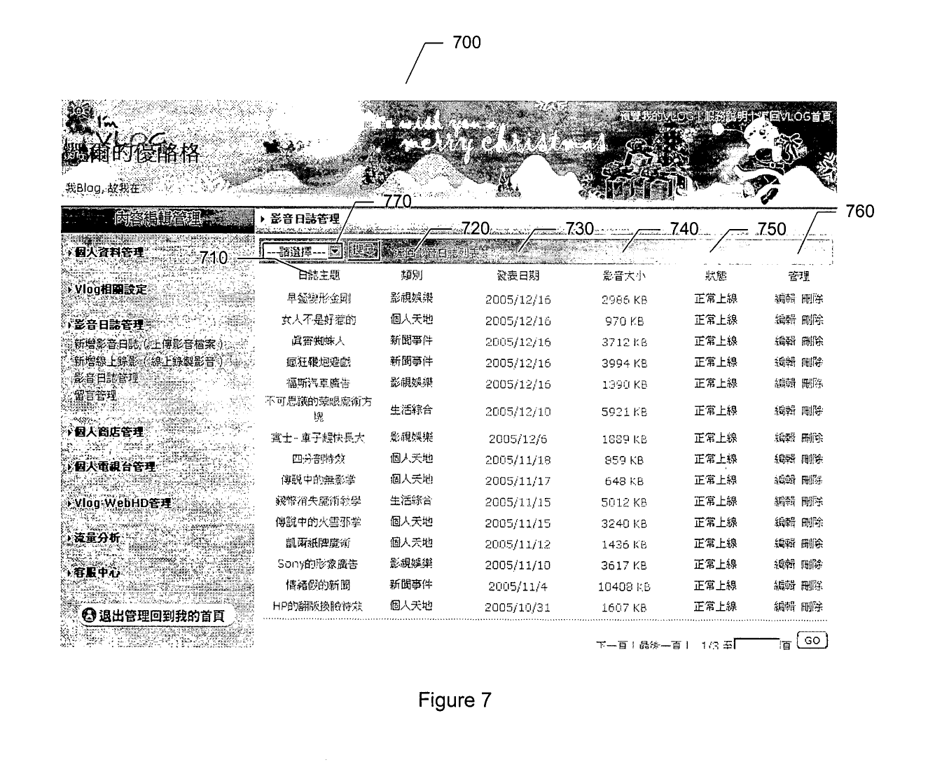

Refer to FIG. 7, which is a drawing illustrating video file maintenance section 700 according to an embodiment of the present invention. Videos that have been recorded or uploaded are displayed in a list. The video name 710, video type or category 720, the upload or record date 730, the file size 740, and the online status 750 are displayed. Further, videos may be searched for in the search box 770. Users can edit or delete files directly from the action column 760.

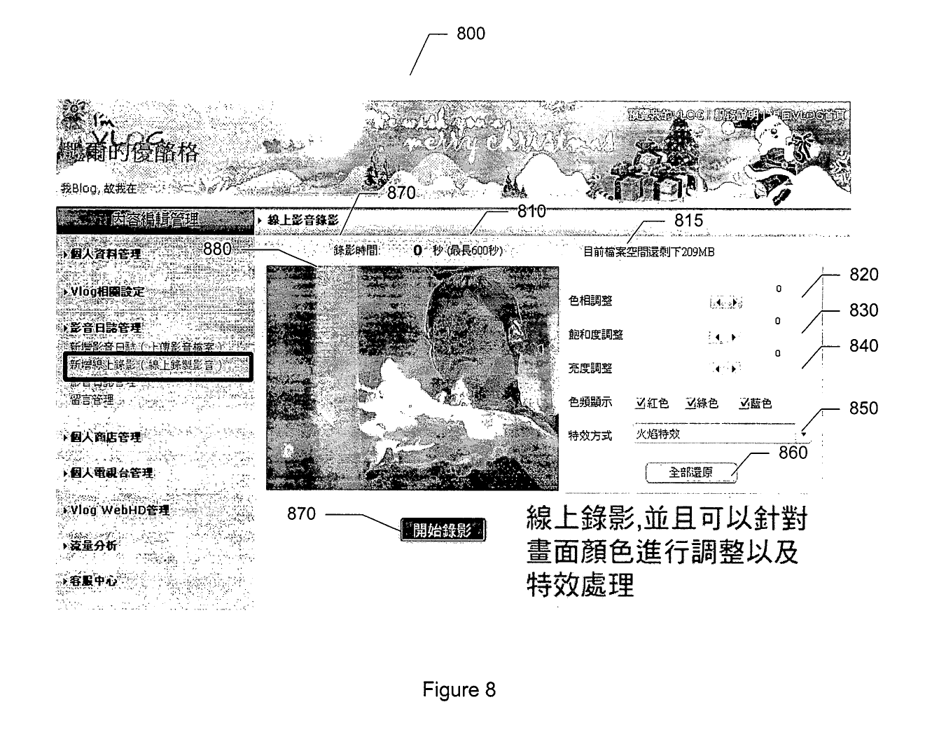

Refer to FIG. 8, which is a drawing illustrating an on-line recording options page 800 according to an embodiment of the present invention. The present invention provides users with the ability to record videos on-line. Using a simple web camera, the video is recorded directly to a central server. This allows users to easily create videos on-line without the need to upload videos captured off-line. Videos can be uploaded to the VLOG, but the level of convenience is greatly improved by using the on-line record function. Once the video is recorded, it can be previewed. If acceptable, the video is automatically added to a new page in the VLOG. If unacceptable, the video can be deleted and a new video recorded.

Other information displayed on this page are the time length available to record 810, and the amount of free space available 815.

Various video quality settings can be chosen by adjusting the color 820, saturation 830, and brightness 840. This allows users to adjust settings to suit the current environment.

Video effects 850 can be added while recording. In this embodiment, a fire effect is illustrated. However, other video effects are available, such as stretch, mirror, distort, pixelate, etc. This allows users to make their videos more interesting and create a more creative video for their VLOG. If the effect or color settings or not acceptable, the setting can be reset to default settings by clicking the reset button 860.

In an embodiment of the present invention, video effects can be created by users. Once submitted, they can be used by the creator only, or by the public depending upon the effect creator's wishes. In this embodiment, the effects are plug-ins that are easily created using the provider's plug-in development section. As with the other areas of the VLOG invention, this can be accomplished on-line without the need for third-party software. Additionally, effect creators can share their effect with specified users.

The on-line video recording begins once the start recording button 870 is pressed. A preview of the video is displayed in real-time in the recording preview pane 880. When finished recording, the user can preview the video and select whether to re-record or add the video to the VLOG.

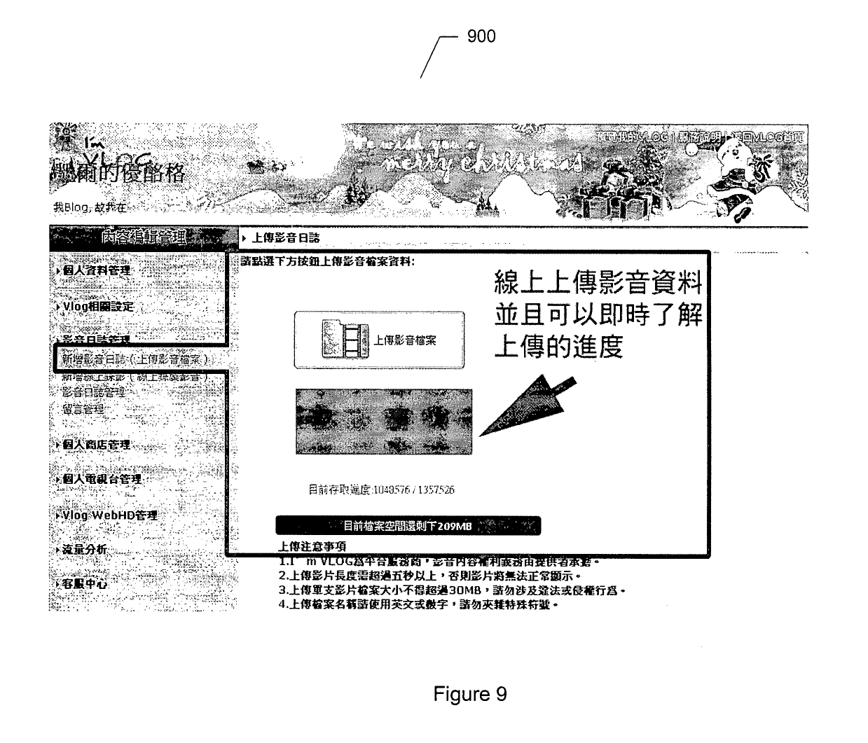

Refer to FIG. 9, which is a drawing illustrating file upload status page 900 according to an embodiment of the present invention. While a video is being uploaded, the upload status can be monitored via the upload status window 900. The percent and size uploaded is displayed to give users upload progress. An advantage of the present invention is that a plurality of codecs is available on the central server so that users can upload video files of any format. Once uploaded, the files are automatically converted to a standard format. For example, a user can upload a file in .avi format and be automatically converted to .wmv format so that all users can view the file.

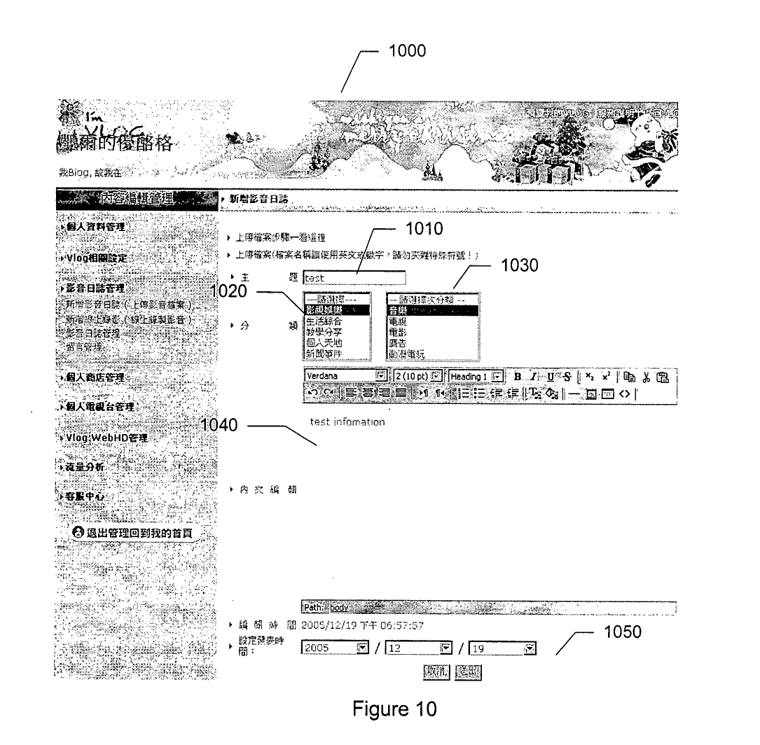

Refer to FIG. 10, which is a drawing illustrating video comments page 1000 according to an embodiment of the present invention. After recording or uploading a video, users can add comments or category information which are associated with the video. A text heading 1010 is provided and is displayed as a heading for the video. The video type 1020 is selected from a variety of category types, for example, news, education, entertainment, sports, etc. Also, the media type 1030 is selected, for example, video, television, movie, web camera, etc.

Below these selections is the video comment field 1040. Users can add a description of the video or various comments or other information. The comment field 1040 also allows users to select text options such as, font, font size, bold, italic, justification, etc. Finally, the creation or upload date 1050 is input for the video.

Once all the information has been input and accepted by the user, the video, comments, description, and other information and input to create a new page or entry in the VLOG. An advantage of the present invention is that all these processes can be accomplished on-line without the need for third party software. The video can be recorded, comments added, and information provided, and VLOG entry automatically created, all on-line within the internet browser.

VLOGs of the present invention can be used in a wide variety of applications. In an embodiment of the present invention, an on-line auction VLOG is provided. Video of the products for sale are presented on individual pages. Users that are interested in purchasing the item can submit their bid either through the comment field or through a submit bid module. The current bidding status is displayed as well as the bidding history.

In another embodiment, the VLOG is a dating site. A user can provide personal videos introducing themselves or showing their personality or talents. Other users that view the videos and are interested in meeting or contacting the video creator can add comments or add their own video comment as feedback or introduction. This greatly facilitates the dating process and allows users to select appropriate matches easily.

In another embodiment, the VLOG is a job or career site. Companies that have job openings can create a VLOG describing the position. Applicants can provide comments, resume, or video introduction. This allows human resource departments to efficiently identify potential candidates and eliminate unnecessary interviews.

In an embodiment of the present invention, when a user signs up to become a member of the main VLOG provider site, the user is given an email account along with the user account. The email account can be a standard email account or a private message account. For example, the standard email account allows users from any email client to contact the user. Private message accounts can only receive mail from messages sent within the VLOG system. As a result, comments or feedback from users can be added to the comment field, or sent privately to the original user. In this way, users can make comments on the video or to the video creator privately. Users can select whether or not to receive email from other users.

When setting up a user account, the user provides as much personal information as they desire. For example, they can provide their name, age, location, relationship status, hobbies, education level, gender, etc. Other users can then search according to these categories. For example, if a user would like to find other users that live in their city and enjoy the same type of music, the user can search with these requirements and all users that meet these parameters are displayed on a results page. Users can then visit the various VLOG pages.

A VLOG can be set up as a personal television station. Users can create a playlist of videos and when another user visits the VLOG, a stream of continuous video is displayed for viewing. This allows users to provide an extended amount of programming. In some embodiments of the present invention, a single video is provided for each VLOG entry. However, with the personal television station embodiment, multiple videos are displayed one after the other without the need for viewer interaction. Since a playlist is utilized, the order of the videos can be modified. Thereby, creative content can be presented by an individual and viewed internationally by a number of users without the need for expensive broadcast equipment.

In another embodiment of the present invention a live chat function is provided. The members that are viewing the current page can interact with on-line discussion or chat in real-time. A list of the current members viewing the page can be displayed. This provides an additional sense of community by allowing real-time communication between members. In this way it is easy to contact others with the same interest or keep in touch with friends without requiring a separate chat client.

In an embodiment of the present invention a web-based forum is provided. This is open to all members to discuss various topics; recommend VLOGs, or discuss other areas. The forum allows users to interact with each other and discover new information or VLOGs that they might not otherwise find.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A video weblog system comprising:
a video display area for displaying a user video;
a text description area for containing a description of the user video;
a video archive preview area for providing screenshots of and access to other user videos; and
an entry calendar for providing access to other videos by date.

2. The video weblog system of claim 1, further comprising:
a video category area for providing access to videos sorted by category.

3. The video weblog system of claim 1, further comprising:
a user comment area for allowing users to comment on the user video.

4. The video weblog system of claim 1, further comprising:
a comment list area for displaying user comments regarding the user video.

5. The video weblog system of claim 1, further comprising:
a video share area for displaying a universal resource locator of the user video.

6. The video weblog system of claim 4, where the user comments are text.

7. The video weblog system of claim 4, where the user comments are in multimedia format.

8. The video weblog system of claim 1, where the user video is recorded directly to a central server.

9. The video weblog system of claim 1, where the user video is uploaded to a central server.

10. A video weblog system comprising:
a video display area for displaying a user video;
a text description area for containing a description of the user video;
a video archive preview area for providing screenshots of and access to other user videos;
an entry calendar for providing access to other videos by date;
a video category area for providing access to videos sorted by category;
a user comment area for allowing users to comment on the user video; and
a comment list area for displaying user comments regarding the user video.

11. The video weblog system of claim 1, further comprising:
a video share area for displaying a universal resource locator of the user video.

12. The video weblog system of claim 10, where the user comments are text.

13. The video weblog system of claim 10, where the user comments are in multimedia format.

14. The video weblog system of claim 10, where the user video is recorded directly to a central server.

15. The video weblog system of claim 10, where the user video is uploaded to a central server.

16. A video weblog system comprising:
a video display area for displaying a user video;
a text description area for containing a description of the user video;
a video archive preview area for providing screenshots of and access to other user videos;
an entry calendar for providing access to other videos by date;
a video category area for providing access to videos sorted by category;
a user comment area for allowing users to comment on the user video;
a comment list area for displaying user comments regarding the user video; and
a video share area for displaying a universal resource locator of the user video.

17. The video weblog system of claim 16, where the user comments are text.

18. The video weblog system of claim 16, where the user comments are in multimedia format.

19. The video weblog system of claim 16, where the user video is recorded directly to a central server.

20. The video weblog system of claim 16, where the user video is uploaded to a central server.
